(19) United States
(12) Patent Application Publication
(10) Pub. No.: US 2004/0226684 A1
(43) Pub. Date: Nov. 18, 2004

(54) Heating and air conditioning plant for motor vehicles with a longitudinally arranged evaporator unit

(76) Inventors: Gerald Richter, Aachen (DE); Thomas Ehlers, Krefeld (DE)

Correspondence Address: Eric J. Sosenko, Esq., BRINKS HOFER GILSON & LIONE, P.O. Box 10395, Chicago, IL, 60610, US

(21) Appl. No.: 10/782,308

(22) Filed: Feb. 19, 2004

(30) Foreign Application Priority Data
Feb. 19, 2003 (DE) 103 07 641.7-16

(51) Int. Cl. B60H 3/00; B61D 27/00; F28F 27/02

(52) U.S. Cl. 165/42; 165/103

(57) ABSTRACT

The invention relates to a heating and air conditioning plant for motor vehicles. The plant includes an evaporator to create cold air, a heating heat exchanger to create warm air, a mixing space to mix warm and cold air in direction of flow of the air channel system and from which the air is directed to the air conditioning zones to be differently tempered through suitable air directing devices and air outlet devices. In longitudinal direction of the vehicle, the evaporator is arranged longitudinal in the bottom region of the instrument panel center console and connected via the air directing channel system to the heating heat exchanger positioned above the evaporator and oriented almost horizontal. The air mixing chamber is configured as parallel-symmetric air guiding system with trapezoidal ducts to deviate the air flows for the left and right air outlets above the heating heat exchanger. A separating wall, impermeable to humidity and air, extends over the width of the heating heat exchanger and a part of the mixing space.

### BACKGROUND OF THE INVENTION

The invention relates to a heating and air conditioning plant, the components of which are preferably arranged longitudinal in direction of the vehicle main axis and thereby enables different air conditioning zones to be created in the interior of the vehicle.

With the permanent development of motor vehicles, particularly of small runabout cars, space-saving components are required in the vehicle interior. Above all, in the front region it is necessary that the foot region should be optimized to ensure sufficient leg room. The optimization focuses on space-consuming components and technical accessories, such as the components of the air conditioning and heating units and their architecture in the area of the center console and the leg rooms laterally adjacent to it.

The evaporators of traditional heating and air conditioning units are arranged transverse to the vehicle main axis. The physical size of the evaporators depends on the heat transfer surface required and thus determines the lateral extension of the center console in direction of the foot regions. Insufficient space conditions, too small leg room, optical shortcomings of the encasing of air channels, evaporator, mixing channels or heating heat exchangers, and safety aspects in case of accidents essentially contributed to the desire to redesign the arrangement of the components of the heating and air conditioning units, relative to each other and their cooperation.

Smaller-size heating and air conditioning units have been seen in the market and are extensively disclosed. In U.S. Pat. No. 5,950,711, the heating heat exchanger and the evaporator are arranged longitudinal in the vehicle after each other so that both form and “V” open to the vehicle bottom. Both components are aligned transverse to the vehicle main axis. While this arrangement reduces the extension (in the direction of the vehicle main axis) into the vehicle interior, no reduction of the extension in the direction of the vehicle main axis into the vehicle interior, no reduction of the extension in direction of the vehicle transverse axis is achieved due to the physical width of the components. The evaporator unit and heating heat exchanger are arranged below the fan in this case and extend into the leg room of the driver and front-seat passenger.

The above mentioned systems would not be capable of being installed in the space provided in runabout cars, because the leg room required is not only longitudinally, but also in direction of the width of the foot region. Innovative developments such as a steering column offset (in the direction of the vehicle main axis) and the architecture of a glove box and/or storage shelf arranged in the front region have a detrimental effect on the space conditions in the foot region.

From U.S. Pat. No. 5,927,382 an evaporator for vehicle air conditioning units is known that, in the scenario of an accident protecting the driver and front-seat passenger, moves horizontally along its rotational axis within an air channel into the position parallel to the vehicle transverse axis. In the scenario of its basic state, it is longitudinally oriented and swiveled by a defined angle to the vehicle main axis. While this arrangement avoids overhanging of the evaporator in the direction of the vehicle interior, the rotation in case of a collision requires the design to keep space in the ventilating channel that corresponds to the radius of rotation defined by its size. In its structural width, the resulting total system only slightly differs from standard systems with a horizontal evaporator.

From U.S. Pat. No. 4,022,599 an evaporator for vehicle air conditioning units is known that is arranged horizontal to the vehicle main axis at the end of an air channel in the central region of the front console. The air to be cooled is fed to the evaporator through air inlets provided in an air channel arranged between the front seats. An advantage is, despite the horizontal arrangement of the evaporator, that the place of installation is below the front console. To avoid irritating flow noise, however, it is necessary to chose accordingly large dimensions for the air channel, which has a particularly disadvantageous effect on the space conditions in the foot region and therefore the leg room. These space problems are partly addressed by a one-sidedly concave cross-section of the air channel in the foot region.

Another proposal to optimize space conditions by arranging the components horizontal in the space provided above the foot space has a very negative effect on the air conditioning. Also the realization of a defined mixing ration of differently tempered air flows to achieve the desired temperature is critical, because of the narrow air channel installation. Horizontal evaporators tend to generate condensed water, particularly when the fan was switched off after the air conditioning unit has been operated. Since no drip pan is provided below the evaporator, there is the danger that condensed water will drip into the foot room.

In U.S. Pat. No. 5,857,905 and U.S. Pat. No. 6,308,770 longitudinally aligned evaporators in connection with other components of an air conditioning unit are offered. The disadvantage of these arrangements is that due to their physical width, they are located between the engine and passenger compartments and therefore cannot completely take space requirements into account. Independent of this fact, the air is supplied by means of two fans of different sizes, which deliver physically separated air flows, namely for heating the windows and for the left and right front outlets.

### BRIEF SUMMARY OF THE INVENTION

Considering this state-of-the-art, it is the object of the invention to provide a heating and air conditioning unit that has small installation dimensions, offers optimized flow conditions for the guidance of the air and creates different air conditioning zones in the interior of the vehicle, in accordance with a new arrangement of the heating heat exchanger and the evaporator.

In systems with a changed arrangement of evaporator and heat exchanger, new, more complex demands are placed on the air flow guidance, compared with traditional systems, to realize differently tempered zones.

In this connection, the air guidance for the distribution of the air flows among the left and right outlets of the front region has to be adapted to the new arrangement.

According to the invention, this problem is solved by an evaporator being arranged in the vehicle's longitudinal direction in the bottom region of the center console and connected via a channel system to a heating heat exchanger that is arranged almost horizontal above the evaporator. An air mixing chamber, as a parallel-symmetric air guiding system with trapezoidal ducts to deviate the air flows to the left and right outlets, is provided above the heating heat exchanger and a separating wall, impermeable to humidity and air, extends over the width of the heating heat exchanger and part of the mixing space.

The almost horizontal arrangement of the heating heat exchanger is characterized in that the heating heat exchanger is passed vertically, that is from bottom to top.

The longitudinal arrangement of the evaporator allows the possibility of configuring the center console in the foot regions of the driver and front-seat passenger on both sides concave in the z-y plane, which leads to a space advantage over traditional systems. Due to the arrangement of the evaporator and the heating heat exchanger above each other, i.e. in z-direction, and the displacement of both components along the vehicle main axis direction, the extension of the center console into the vehicle interior is reduced. The significant problem of the development and removal of condensed water is confronted by the upright and longitudinal arrangement of the evaporator. In a further embodiment of the invention, a condensate drain can be provided below the evaporator.

The air is conditioned as in conventional 2-zone heating and air conditioning units; the guidance of the air, however, is characterized by the air directing and deviation according to the invention. The air is supplied to the evaporator through a fan, cooled in the evaporator if necessary, and subsequently divided into two identical partial volume flows, namely for the left passenger side and for the right passenger side, by means of a separating wall that physically divides the heating heat exchanger and the mixing chamber. The separating wall, which is detachably or not detachably connected to the heating heat exchanger and preferably designed impermeable to humidity and air, extends over the width of the heating heat exchanger and part of the mixing chamber.

Each of said partial volume flows is, in the scenario of the summer operational mode, directly supplied to the air guiding system downstream of the heating heat exchanger. The volume flow is further divided only if there is a demand to mix a warm and cold air at the same time via the “temperature controls”. The “temperature controls” each are connected to a warm and cold air flap that are arranged longitudinal. The desired air tempering can be realized separately for the driver and the front-seat passenger, whereby a partial volume flow passes the heating heat exchanger and the complementary portion flows directly into the mixing chamber arranged, in the direction of flow, upstream and downstream of the heating heat exchanger. In the mixing chamber the temperatures of both volume flows are leveled out, depending on the desired air tempering, separately for the driver and the front-seat passenger.

Thus, the separation of the air flows to achieve different air conditioning zones takes place for the possibly cooled air already in the mixing chamber, which is provided with a separating wall arranged transverse to the vehicle main direction. By design, both warm air flows passing the heating heat exchanger are arranged after each other along the vehicle main axis direction so that they, after having been mixed with the cold air flow in the top region of the mixing chamber are subjected to a subsequent air deviation.

To realize different tempering zones, namely for the left and right passenger sides, the air flows have to be divided and supplied to the respective air outlets over the air distribution system. As there is only one refrigerant circuit, comprising the components of a compressor, throttle element, evaporator and collector, used in the motor vehicle or heating circuit, the single air lows are divided by a separating wall, whereas air mixing is realized in the top region of the mixing chamber.

The air flows are deviated in direction of flow by the air guiding system located above the mixing chamber downstream of the heating heat exchanger. By the air guiding system, the air flows are directed by a parallel-symmetric arrangement of air ducts and, especially advantageously, rotated by 90°.

The arrangement of the evaporator and heating heat exchanger according to the invention creates the required free space for a mixing chamber, in which the warm and cold air flows, if necessary, can be completely mix free of temperature streaks.

Accordingly, the significant features of the invention include, without limitation:

an evaporator arranged longitudinal in the bottom of the center console;

a heating heat exchanger arranged almost horizontal above the evaporator in the top region of the center console;

air mixing chamber configured as a parallel-symmetric air guiding system to realize a change of the direction of the air flows by 90°; and

temperature controls, which allows control of the longitudinal arranged warm and cold air flaps, also commonly, if required.

### BRIEF DESCRIPTION OF THE DRAWINGS

In the following, the invention will be explained by means of an example of embodiment with reference to the drawings.

The figures show:

FIG. 1—front view, arrangement of center console;

FIG. 2—perspective view, arrangement of center console;

FIG. 3—side view, arrangement of center console;

FIG. 4—simulation study of the airflow;

FIG. 5—separating wall and air flaps;

FIG. 6—parallel-symmetric air guiding channels, or air guiding system; and

FIG. 7—representation of the airflow in mixed state.

### DETAILED DESCRIPTION OF THE INVENTION

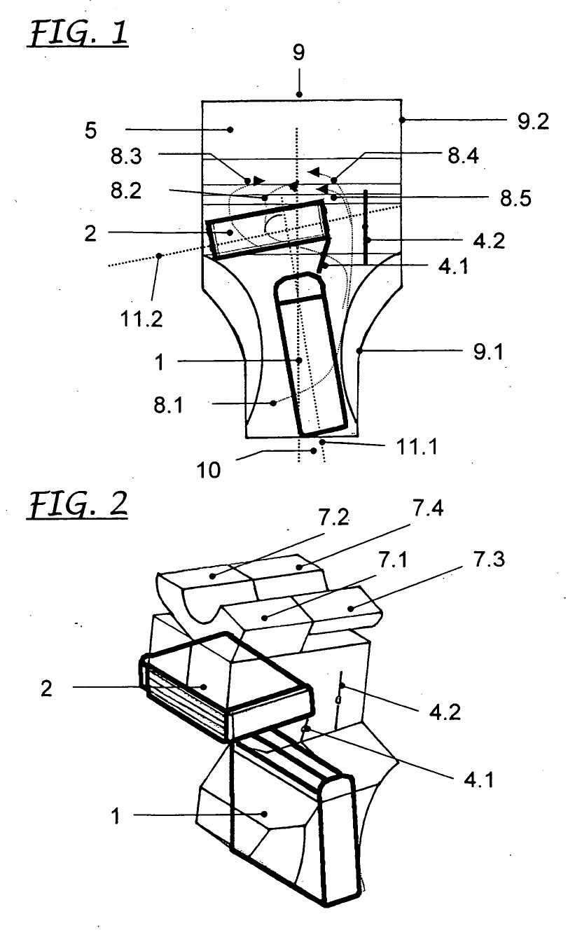

FIG. 1 shows the new arrangement according to the invention of the evaporator 1 and the heating heat exchanger 2 as well as their mutual arrangement in front view. The heating heat exchanger 2 is arranged almost horizontal above the evaporator 1 in the instruments zone of the center console 9.2. Both components are aligned to each other such that the evaporator 1 and the heating heat exchanger 2 in the vehicle main axis form an “L” swiveled by 180°.

Further, FIG. 1 shows the common inclination of the evaporator 1 and the heating heat exchanger 2 relative to the z-axis. The inclination depends on the type of the vehicle and the necessary size of the evaporator 1; the angle α ranges preferably from 0° to 50°. In the foot region of the center console 9.1 the ventilating duct completely surrounds the evaporator 1. The evaporator 1 with its physical height takes up the total space available within the center console 9, which ends in the foot region. It is seen that the foot region of the center console 9.1 is dimensioned very narrow widening in the area of the central air outlets. Due to its structural size the heating heat exchanger 2 is not important for the width of the center console in the instruments region 9.2.

FIG. 2 shows the left and right air outlets 7 for the windshield, 7.1, 7.3, and the console 7.2, 7.4. Further, it is seen that the evaporator 1 advantageously is offset relative to the heating heat exchanger 2 along the vehicle main axis, i.e. the x-axis, towards the engine compartment to enlarge the foot region.

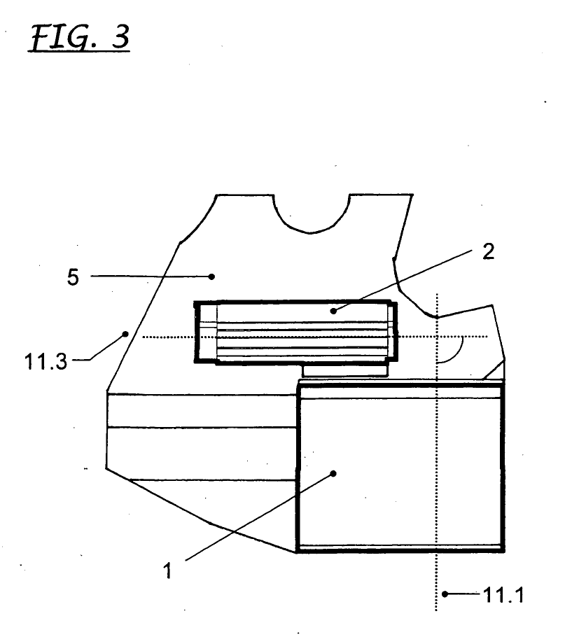

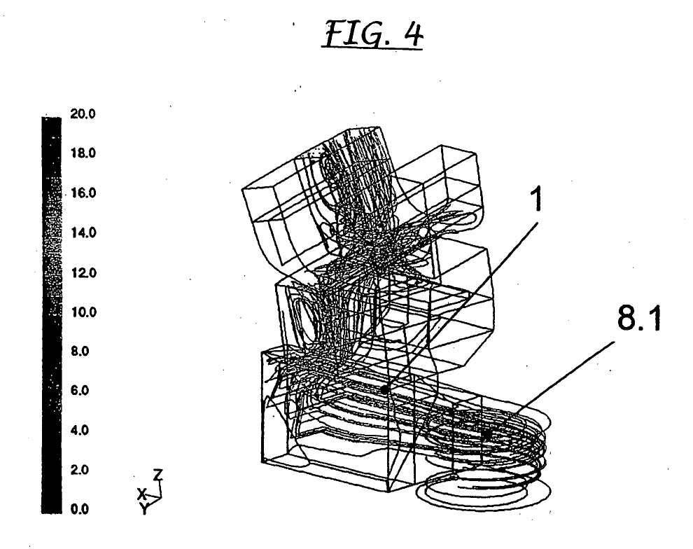

In FIG. 3 the arrangement and mutual alignment of the evaporator 1 and the heating heat exchanger 2 are illustrated. In this view the orthogonal alignment of the main transformation axes 11 of these components is made particularly clear. The evaporator 1 is offset relative to the heating heat exchanger 2 towards the engine compartment along the vehicle main axis, or main transformation axis x. This reduces distinctly the lateral extension of the center console in the foot region 9.1 compared with the conventional arrangements.

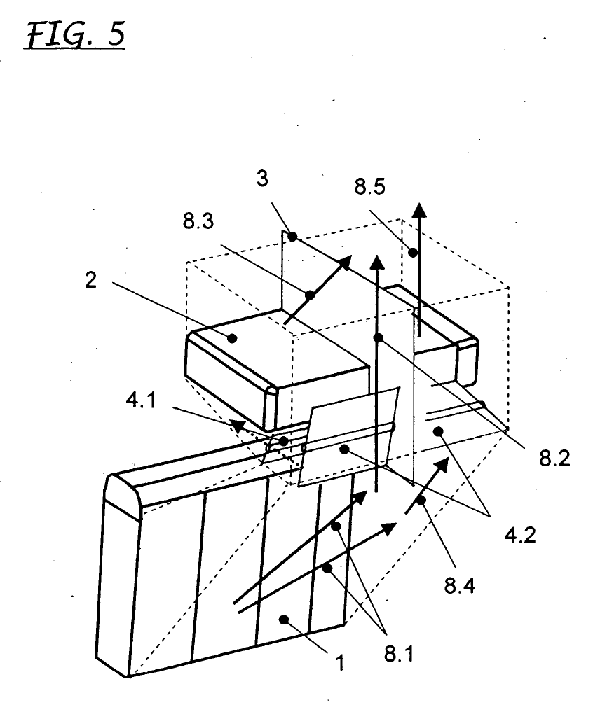

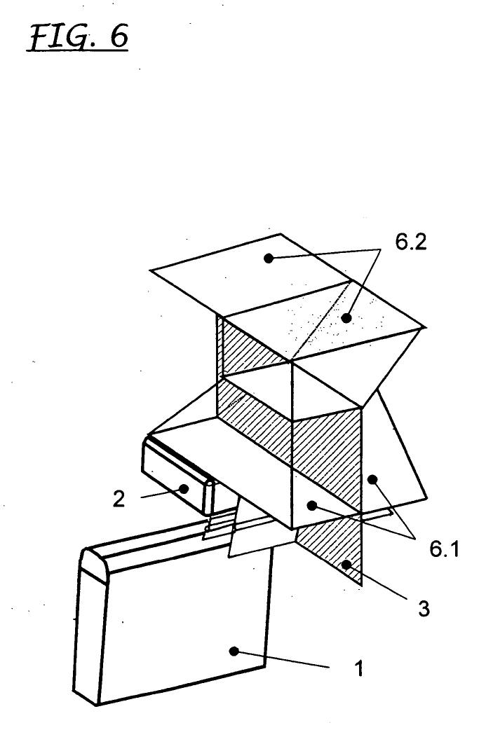

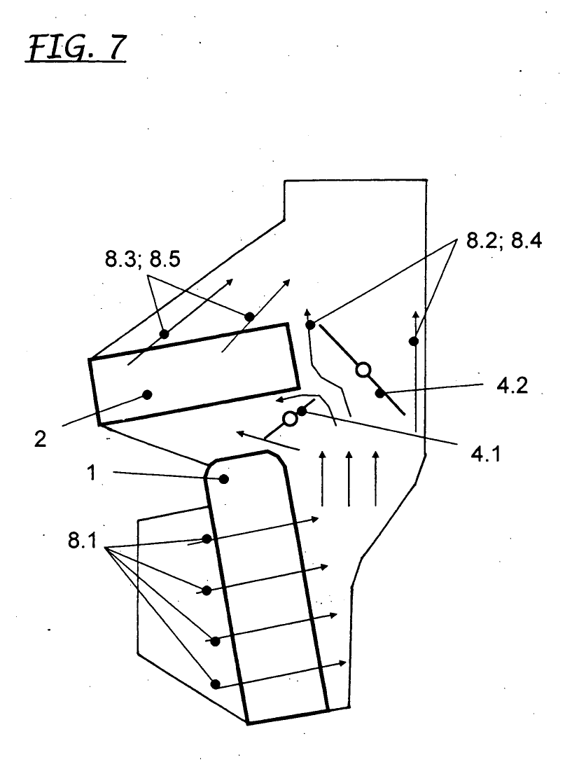

FIG. 4 shows a simulation study, FIGS. 5 and 6 show graphic representation of the air flow through the heating and air conditioning unit. The air is sucked in on the front side of the evaporator 1 through the fan not shown. The direction of the passage of the air to be conditioned 8.1 is transverse (FIG. 5) to the vehicle main axis so that all the heat exchanging surface available of the evaporator 1 can be used to condition the air.

The air supply 8.1 of the air to cooled to the evaporator 1 is advantageously in the foot region of the center console 9.1 on the front side of the evaporator 1, i.e. in the z-y plane (FIG. 5). The cooled air is then led vertically and divided into up to four air flows 8.2 to 8.5 depending on the temperature set at the “temperature controls” and the separating wall. The temperature is set by separate warm air flaps 4.1 and cold air flaps 4.2 with actuator, by which each volume flow portion of the warm and cold air is set.

A detailed sectional view of the arrangement according to the invention of the evaporator 1 and the heating heat exchanger 2 and the accompanying flow paths of the various volume flows 8.1 to 8.5 is shown in FIG. 7. In the mixing state the flow path for the warm air flows 8.3 to 8.5 to pass the heating heat exchanger 2 is opened by the warm air flap 4.1. When only cold air is desired in the vehicle interior, the sucked air 8.1 flows directly from the evaporator 1 into the air guiding system downstream of the heating heat exchanger 2.

In order to be able to realize a desired heating of the vehicle interior, only that portion of the volume flow that is led over the heating heat exchanger 2 must be increased by an adjustment of the air flaps 4.1 and 4.2 (FIG. 5). The total volume flow is always constant during pure temperature control.

Another advantageous further development of the invention consists in that the warm air flap 4.1 and cold air flap 4.2 can be actuated together via a “temperature control” and therefore the heating and air conditioning unit can be operated in one-zone mode. The rotational axes of both air flaps 4 would have to be aligned after each other in longitudinal direction along the vehicle main axis.

The cold air volume flow divided into two portions 8.2, 8.4 by the separating wall 3 flows directly from the evaporator 1 through a channel system into the mixing chamber 6 and mixes in accordance with the thermodynamic mixing rule for temperature balancing with the heated air flows 8.3 and 8.5, which were conducted through the heating heat exchanger 2. Thus the complementary air flows are the air flows 8.2 and 8.3, and 8.4 and 8.5 (FIG. 5).

The air flows to be heated 8.3 and 8.5 pass the heating heat exchanger 2 and are heated. Then the heated air flows together with their complementary cold air flows 8.2 and 8.4 are supplied to the trapezoidal ducts 6.1 designed as mixing chambers (FIG. 5 and FIG. 6).

The top range of the mixing chamber 6 is positioned above the heating heat exchanger 2 in vertical arrangement. Above the heating heat exchanger 2 the separated and mixed air is led via the air guiding system of the invention, which consists of two parallel-symmetric air ducts 6, and rotated by 90° according to the invention. Via a conventional air channel system (not shown) the air is directed to the left and right air outlets 7, with the air outlets 7 operated by the driver and front-seat passenger, respectively, according to the desired volume flows.

The parallel-symmetric air directing ducts each include two identical trapezoidal ducts 6.1, 6.2, which with their most narrow side are positioned one above the other such that the ducts for the inlet and the outlet of the air 6.1, 6.2 are rotated by an angle of 90° (FIG. 6). Via the wider duct side open to the bottom of both first trapezoidal ducts 6.1, which overspans the heating heat exchanger 2 and a portion of the mixing chamber as well, heated and possibly cooled air is sucked simultaneously and mixed. The arrangement of the trapezoidal ducts 6.1, 6.2 is such that the biggest sectional area passed is in each case provided at the beginning and at the end of these trapezoidal ducts 6.1, 6.2.

The first trapezoidal ducts 6.1, which face the heating heat exchanger 2, for the left and right air outlets 7 are configured opposite and horizontal to the vehicle main axis. Due to the trapezoidal shape and, therefore, the reduction of the sectional area passed of the first duct 6.1, the flow velocity increases until the transition from the first trapezoidal duct 6.1 to the second trapezoidal duct 6.2 is reached. At the exit of the first trapezoidal duct 6.1 the air volume flows have already been aligned to be orthogonal to the vehicle main axis (FIG. 6). In the direction of flow, for each left and right side of a second trapezoidal duct 6.2 follows aligned longitudinal to the vehicle main axis. At the end of the second trapezoidal duct 6.2 the air flows have been deviated by 90° and are led to the air outlets 7 (not shown).

The flow velocities of the tempered air are almost constant at the beginning and the end of the air deviation and are only reduced by friction losses in flow direction. For the expert, however, it is apparent that the trapezoidal ducts 6.1, 6.2 to conduct and lead the air are identical for the left and right sides.

The foregoing discussion discloses and describes a preferred embodiment of the invention. One skilled in the art will readily recognize from such discussion, and from the accompanying drawings and claims, that changes and modifications can be made to the invention without departing from the true spirit and fair scope of the invention as defined in the following claims.

1. Heating and air conditioning plant fro motor vehicles comprising an evaporator to create cold air, a heating heat exchanger to create warm air, a mixing space to mix warm and cold air in direction of flow of an air channel system and from which the air is directed to air conditioning zones to be differently tempered over suitable air directing devices and air outlet devices, in vehicle longitudinal direction the evaporator is arranged longitudinal in the bottom region of a center console and via the air channel system is connected to the heating heat exchanger positioned above the evaporator and almost horizontal and to an air mixing chamber positioned above the evaporator and configured as a parallel-symmetric air guiding system with trapezoidal ducts to deviate the air flows for left and right air outlets above the heating heat exchanger, and a separating wall impermeable to humidity and air extending over the width of the heating heat exchanger and part of the mixing space.

2. Heating and air conditioning plant of claim 1 wherein the evaporator and the heating heat exchanger are arranged such that they are commonly inclined by an angle α to the vertical.

3. Heating and air conditioning plant of claim 2 wherein the angle α ranges from 0° to 50°.

4. Heating and air conditioning plant of claim 1 wherein main transformation axes of the evaporator and the heating heat exchanger are orthogonal to each other.

5. Heating and air conditioning plant of claim 1 wherein the evaporator and the heating heat exchanger are displaced relative to each other in vehicle longitudinal direction.

6. Heating and air conditioning plant of claim 1 wherein the center console in a foot region in the z-y plane is configured concave on both driver and front-seat passenger sides.

7. Heating and air conditioning plant of claim 1 wherein the mixing chambers are configured as two parallel-symmetric directing channels with cross-sections reducing and subsequently enlarging in flow direction.

8. Heating and air conditioning plant of claim wherein a change of the flow direction of about 90° and air flows for the left and right sides at the outlets of the parallel-symmetric air guiding system are led almost parallel to the alignment of the evaporator.

9. Heating and air conditioning plant of claim 1 wherein the parallel-symmetric air guiding system consists of two trapezoidal ducts each are connected each to the other such that the largest section area passed in each case is at the beginning and at the end of said ducts.

10. Heating and air conditioning plant of claim 1 wherein said heating and air conditioning plant is configured to function as a one-zone air conditioning unit through connection of the left and right air flaps.
